(19) United States
(12) Patent Application Publication
(10) Pub. No.: US 2009/0267344 A1
(43) Pub. Date: Oct. 29, 2009

(54) WATER PUMP HAVING A SPHERICAL BALL COUPLING

(75) Inventor: Gerard ANDREI, SAINT CYR SUR MER (FR)

Correspondence Address: LUCAS & MERCANTI, LLP, 475 PARK AVENUE SOUTH, 15TH FLOOR, NEW YORK, NY, 10016, US

(73) Assignee: GATECH, Gemenos (FR)

(21) Appl. No.: 12/390,896

(22) Filed: Feb. 23, 2009

(30) Foreign Application Priority Data
Apr. 28, 2008 (FR) 08 52835

(51) Int. Cl. F16L 27/08

(52) U.S. Cl. 285/261

(57) ABSTRACT

The present invention relates to a swimming pool water pump having connection couplings for connection to fluid flow piping for the purpose of circulating a fluid, preferably for a swimming pool or for a swimming bath, at the fluid suction orifice of the pump and/or at the fluid delivery orifice of the pump, said pump having at least one said connection coupling integrated into the pump at the said delivery orifice or at the said suction orifice, said coupling having a spherical ball ending in an inclined cylindrical tubular end-piece suitable for inter-fitting with the end of a said fluid flow pipe, so that the axis of said cylindrical end-piece of said spherical ball coupling can pivot in all directions through an angle α varying from −αmax to +αmax relative to the axis of said delivery orifice or of said suction orifice of the pump, where αmax is at least equal to 20°, preferably lies in the range 25° to 60°, and more preferably lies in the range 30° to 45°.

### FIELD OF THE INVENTION

The present invention relates to a swimming pool water pump having connection couplings for connection to fluid flow piping for the purpose of circulating a fluid, preferably for a swimming pool or for a swimming bath, at the fluid suction orifice of the pump and/or at the fluid delivery orifice of the pump.

### BACKGROUND OF THE INVENTION

It is sometimes a long and difficult task to install the pump and to couple it firstly to the water inlet circuit of the swimming pool and secondly to a feed pipe of the sand filter. In particular, it is sometimes necessary to provide numerous bends in order to cause the suction orifice to coincide with the water inlet pipe conveying water from the swimming pool, be it from the surface suction skimmer or from the bottom bung, or from other means for sucking water from the swimming pool, and not only does that sometimes pose compactness difficulties, it also affects the efficiency of the pump. The resulting multitude of bends inevitably gives rise to head loss and adversely affects the fluid flow and the efficiency of the pump.

### OBJECT AND SUMMARY OF THE INVENTION

To solve that problem, the present invention provides a swimming pool water pump having connection couplings for connection to fluid flow piping for the purpose of circulating a fluid, preferably for a swimming pool or for a swimming bath, at the fluid suction orifice of the pump and/or at the fluid delivery orifice of the pump, said pump having at least one said connection coupling integrated into the pump at said delivery orifice or at said suction orifice, said coupling having a spherical ball ending in a cylindrical tubular end-piece suitable for inter-fitting with the end of a said fluid flow pipe, wherein the axis X₂X′₂ of said cylindrical end-piece is inclined relative to the axis X₁X′₁ of said spherical ball, so that the axis X₂X′₂ of said cylindrical end-piece can pivot in all of the rotation directions relative to the axis XX′ of said delivery orifice and/or of said suction orifice of the pump, and presents an inclination relative to the axis XX′ of said orifice of the pump, by an angle α that, in absolute terms, is less than or equal to αmax, where αmax lies in the range 25° to 60°, and preferably in the range 30° to 45°.

It can thus be understood that the axis X₂X′₂ of said cylindrical end-piece of the pump can pivot relative to the axis of said delivery orifice or of said suction orifice within a cone having a half-angle at its apex of value αmax, i.e. that the axis X₂X′₂ of the cylindrical end-piece can pivot, in a given direction in rotation of the plane containing said axes X₂X′₂ and X₁X′₁ of the orifice of the pump, over the range from −α₁max to +α₁max.

This possibility for said cylindrical end-piece to pivot at the orifice of the pump makes it much easier to couple the pump to a flow piping installation, in particular in a plant room. The directions in which said pipes arrive at the pump are determined by the location of the swimming pool and/or of the equipment such as the sand filter to which the pump is secured. Unfortunately, an offset of only a few degrees can make it necessary to implement a plurality of bends in the ducts in order to take up said offset and so that the axis of the water flow pipe at its coupling end coincides with the axis of the cylindrical end-piece.

In addition, by limiting the pivot angle to a value lying in the range 25° to 60°, and preferably in the range 30° to 45° approximately, it is possible to maintain fluid flow that is acceptable for the fluid flowing through the orifice and through the water flow pipes at their couplings, so as not to affect the delivery-rate performance of the pump.

In general, the possibility of avoiding a certain number of large angular variations of the pipes, in particular of avoiding bends in the path of the water flow piping contributes to improving the delivery rate performance of the pump for a given motor, while reducing head loss.

The respective inclinations of the cylindrical end-piece and of the pivot angle of the spherical ball thus make it possible to combine a relatively large angular variation, the inclination of the cylindrical end-piece relative to the axis of the spherical ball and the possible pivot angle through which the spherical ball can pivot relative to the axis of the orifice of the pump make it possible to obtain an angular variation through a relatively large angle for the cylindrical end-piece relative to the axis of the orifice of the pump, without requiring excessive movement in rotation of the spherical ball, thereby making it possible to preserve fluid flow conditions that are satisfactory, as well as leaktightness conditions that are satisfactory for the fluid flowing in the spherical ball coupling.

In a preferred embodiment, the axis X₂X′₂ of said cylindrical end-piece, which axis is referred to as the “second axis”, is inclined by a fixed angle α₂ having a value lying in the range 10° to 30°, and preferably lying in the range 10° to 20° relative to the axis X₁X′₁ of said spherical ball, which axis is referred to as the “first axis”, and said spherical ball can pivot through an angle α₁ from −α₁max to +α₁max between its said first axis X₁X′₁ and the axis of the orifice of the pump XX′ in any rotation direction relative to the axis XX′ of the orifice of the pump, where α₁max lies in the range 15° to 30°, and preferably 15° to 25°, so that the axis X₂X′₂ of said cylindrical end-piece can pivot relative to an axis perpendicular to the axis XX′ of said orifice of the pump by a value from −|a₁max−a₂| to (a₁max+a₂), in a given plane containing said first axis X₁X′₁ and said second axis X₂X′₂, in a given fixed rotation direction relative to the axis XX′ of said orifice of the pump.

More particularly, the angle α₁max is substantially equal to the said angle α₂, of a value lying in the range 15° to 25°, and preferably of a value of 22.5°.

It can be understood that, if the spherical ball pivots to too large an extent, it becomes difficult to preserve the leaktightness of said spherical ball, in particular for a removable coupling as described below. If the angle of rotation αmax or α₁max of the spherical ball is too large, the area over which the spherical ball bears against a concave bearing surface against which it slides in rotation is insufficient for the coupling to be leaktight if, in order to preserve the fluid flow, the end of the spherical ball does not encroach on the water-passing openings with regard to the pump.

In an advantageous variant embodiment:

said orifice of the pump is edged by a bearing part presenting a spherically concave bearing surface provided with a central orifice co-operating with the orifice of the pump and having the same axis of revolution as the axis XX′ of said orifice of the pump; and

said spherical ball has a spherically convex outside surface suitable for pivoting against said concave bearing surface, said spherically convex outside surface being defined by a sphere segment between two section planes that are perpendicular to an axis of revolution referred to as the “first axis” X₁X′₁ and that comprise a first section plane defining a small-diameter section and a second section plane defining a larger-diameter section, and said spherical ball also being provided with a fluid-passing internal cavity defined by a surface of revolution of the frustoconical type having a straight generator line or a curved generator line that is convex on the same side as the internal volume of the cavity about an axis of revolution corresponding to said first axis X₁X′₁, so that said second axis X₂X′₂ that is the axis of said cylindrical end-piece can pivot to a value αmax=α₁max+α₂ in any rotation direction relative to the axis XX′ of said central orifice, said frustoconical cavity presenting a small open circular base at said first section plane and a large open circular base at said second section plane; and

a said cylindrical tubular end-piece extends from said first section plane, said second axis X₂X′₂ is inclined by an angle α₂ relative to said first axis X₁X′₁ of said frustoconical internal cavity, said frustoconical internal cavity being extended by the tubular internal cavity of said cylindrical tubular end-piece, which cavity presents a beveled end whose opening comes to be situated at said small open circular base of said frustoconical internal cavity at said first section plane, and a tubular second end suitable for inter-fitting with the end of a said water flow pipe.

It can be understood that said second axis X₂X′₂ of the cylindrical end-piece can pivot relative to an axis that is perpendicular to the axis XX′ of the central orifice from −|a₁max−a₂| to (a₁max+a₂), in a given direction in rotation of the plane X₁X′₁, X₂X′₂ relative to the axis XX′ of the central orifice, by going through a value a=0 when X₂X′₂ is parallel to the axis XX′ of the central orifice.

It can be understood that said beveled first end of the tubular internal cavity of said cylindrical end-piece is inclined by a said fixed angle a₂ relative to a plane that is perpendicular to said second axis X₂X′₂

More particularly, said spherical ball coupling has a said spherical concave surface separated into two pieces at a third section plane so that said bearing part has a lower first piece of bearing part that has a first spherically concave surface around said pump orifice, and above which an upper second piece of bearing part in the form of a rim-piece comes into abutment, the second spherically concave surface of which rim-piece extends in continuity with said first spherically concave surface, said upper second piece of bearing part in the form of a rim-piece being held in leaktight manner against said lower first piece of bearing part by a clamping collar and by means of an O-ring seal.

More particularly, said clamping collar is provided with a cylindrical thread suitable for co-operating in closure with a complementary thread on the cylindrical outside periphery of the upper portion of said lower first piece of the bearing part.

In a preferred embodiment of the invention, the frustoconical internal cavity presents a straight generator line inclined at an angle (α₃) lying in the range 20° to 30°, and preferably of about 25°, relative to said first axis of revolution X₁X′₁.

Advantageously, a pump of the invention has a said spherical coupling at each of its two orifices, namely its suction orifice and its delivery orifice, said axes of symmetry of which orifices are disposed perpendicularly, said axis of symmetry of the suction orifice preferably being substantially horizontal, and said axis of symmetry of the delivery orifice preferably being substantially perpendicular, and situated above the suction orifice.

The present invention also provides a water flow installation for a swimming pool, said installation including a filtration pump or a counter-current swimming pump of the invention, which pump is connected to water flow pipes at least one said coupling at a said water suction orifice or a said water delivery orifice of said pump, in which coupling the end of said pipe inter-fitted with said cylindrical tubular end-piece of said coupling is inclined relative to the axis of symmetry XX′ of said orifice.

More particularly, in an installation of the invention, the pump has two couplings having spherical balls, and the pipes at the two couplings are inclined by different angles of inclination relative to the axis XX′ of said orifice of the pump.

By means of the spherical ball coupling, the present invention makes it possible to change the direction of the suction orifice or of the delivery orifice of the pump so as to facilitate coupling the pump to a water flow pipe for water coming from or flowing towards a swimming pool, or optionally towards a water treatment device such as a sand filter.

The present invention thus makes it possible to increase the delivery rate of the pump and to reduce the time require for installing the pump in the plant room, while reducing any costs necessary for bringing the rigid water-flow pipe to coincide exactly with the pump orifice in question.

### BRIEF DESCRIPTION OF THE DRAWINGS

Other characteristics and advantages of the present invention appear more clearly on reading the following description given by way of non-limiting illustration and with reference to the accompanying drawings, in which:

FIG. 1 shows a pump of the invention as equipped with two spherical ball couplings;

FIG. 1A shows a pump of the invention as coupled to water flow pipes;

FIG. 1B shows how pipes are coupled to suction orifices 1a and 1b of a pump 1d that is not equipped with spherical ball couplings of the invention;

FIGS. 2A and 2B show different perspective views of the cover 1c of the pumping portion proper of the pump, which cover is provided with a suction orifice 1a and with a delivery orifice 1b, which orifices are equipped with spherical ball couplings of the invention;

FIG. 3 is a section view at the spherical ball 200b at the suction orifice 1b;

FIG. 4 is a section view at the spherical ball 200a at the delivery orifice 1a;

FIG. 5 is a view of the detail A of FIG. 4;

FIGS. 6 and 7 are section views at the spherical ball coupling 200b co-operating with the suction orifice 1a of the pump in respective ones of the two opposite maximum pivot positions of the spherical ball, through an angle a=a₁+a₂ (FIG. 7) and through an angle a=a₁−a₂ (FIG. 6); and

FIG. 8 is a section view showing a spherical ball 210 of a coupling of the invention.

### MORE DETAILED DESCRIPTION

The figures show a counter-current swimming pump 1 including a portion with its electric motor 10a that co-operates with a pumping portion proper 10b containing an internal impeller (not shown) covered by a metal cover 1c provided with two orifices, namely an axial orifice 1b corresponding to a suction orifice for sucking in the water from a water inlet duct 10₁, and a side orifice 1a or “delivery orifice” making it possible for water to be delivered into a duct 10₂ in a direction that is tangential relative to the circular movement of water flow inside the cover 1c that is of circular section.

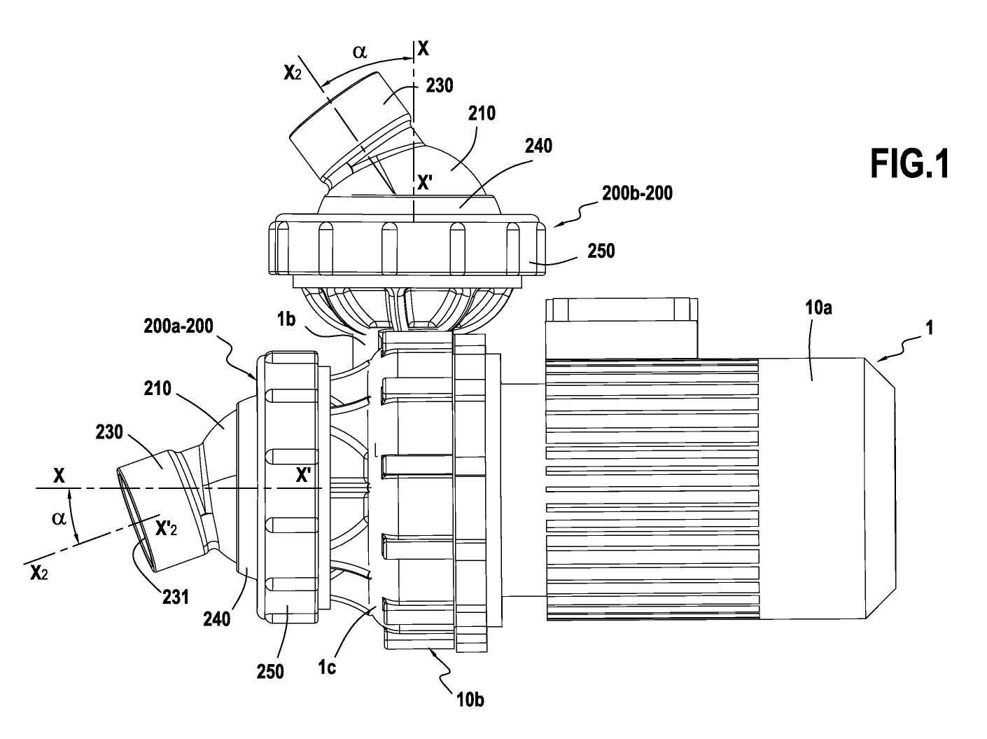

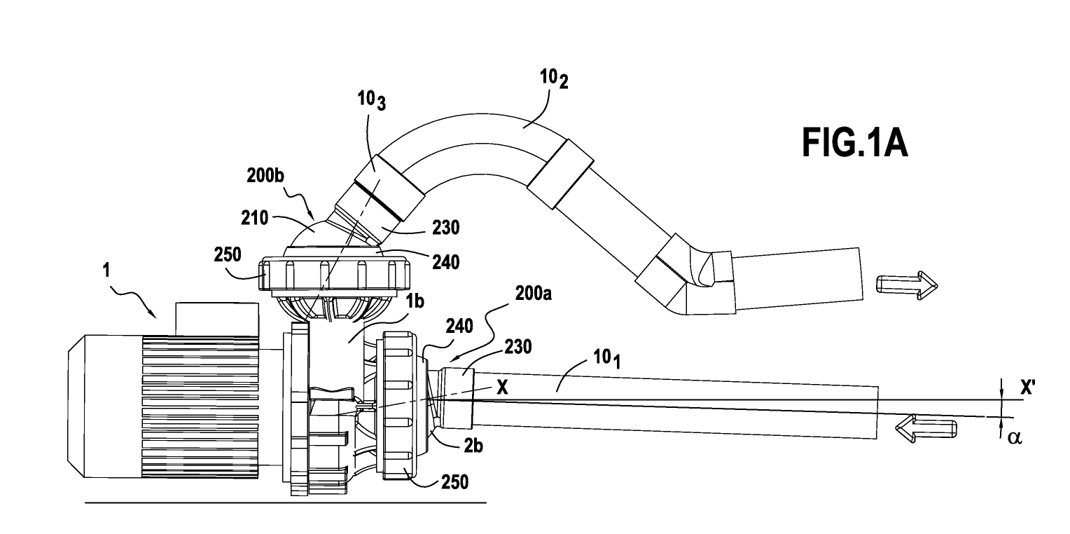

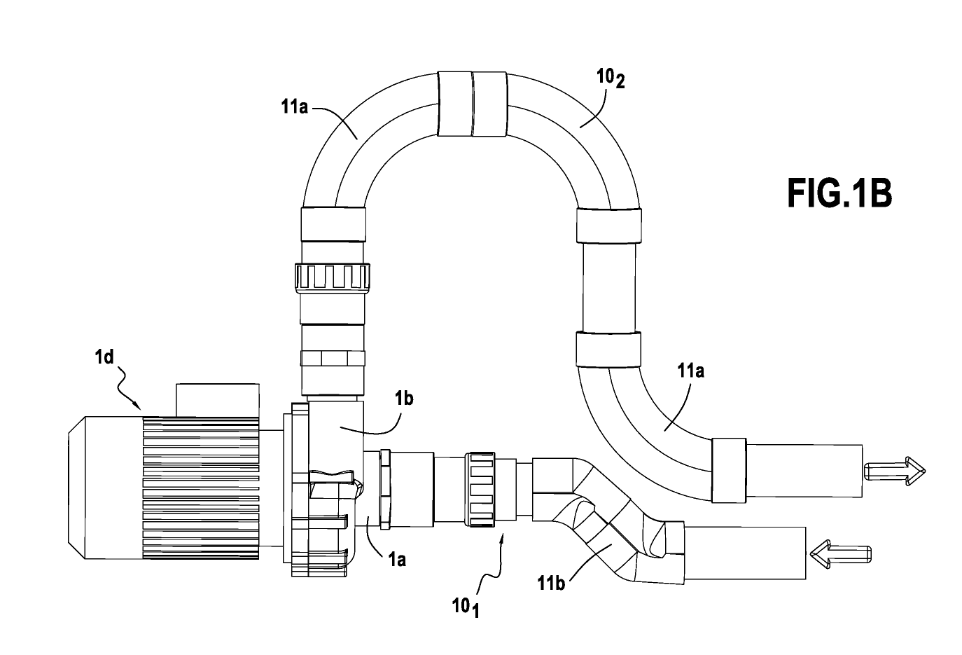

In FIG. 1B, it can be seen that, in the absence of a spherical ball coupling of the invention, and in order to install the pipes 10₁, 10₂, it can be necessary to implement tubular couplings provided with bends 11a or a coupling having a duct portion that is inclined relative to its ends 11b, in order to come into alignment with the axes of the orifices 1a and 1b of the pump 1d.

In FIGS. 1 and 1A, it can be seen that the pump 1 of the invention is provided with two couplings 200a and 200b of the invention, having spherical balls 210.

As shown in FIG. 1A, when the pump is disposed substantially horizontally at ground level, for example, the axis of symmetry of the suction orifice is disposed substantially horizontally, while the axis of symmetry of said delivery orifice is disposed perpendicularly and above said suction orifice. However, as shown in FIG. 1A, the spherical ball couplings of the invention make it possible to couple the pump to inlets 10₃ of said water suction duct 10₁ and of said water delivery duct 10₂, which ducts are not disposed at 90° relative to each other, by means of the spherical balls of said couplings moving in rotation, as explained below.

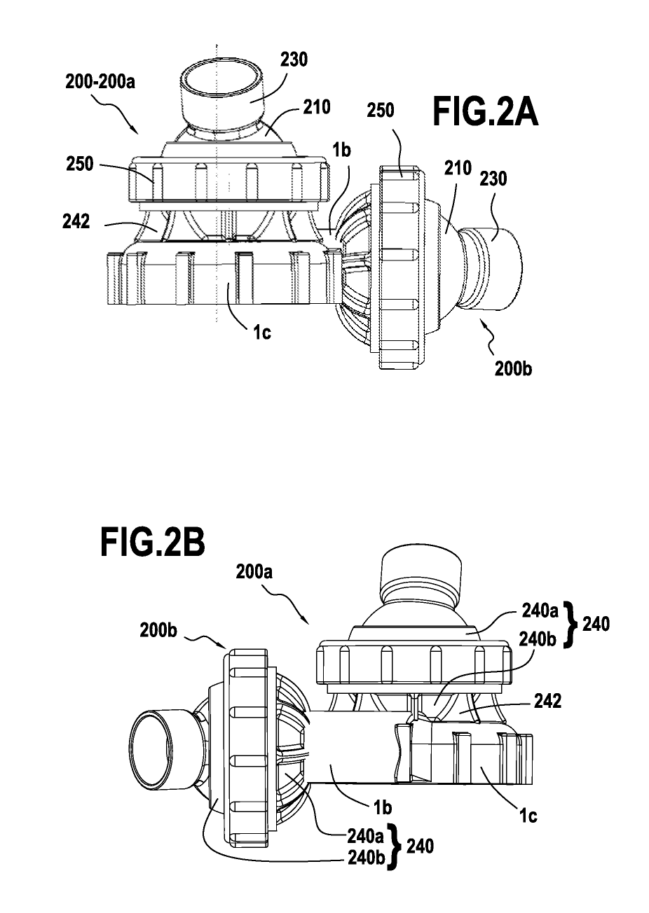

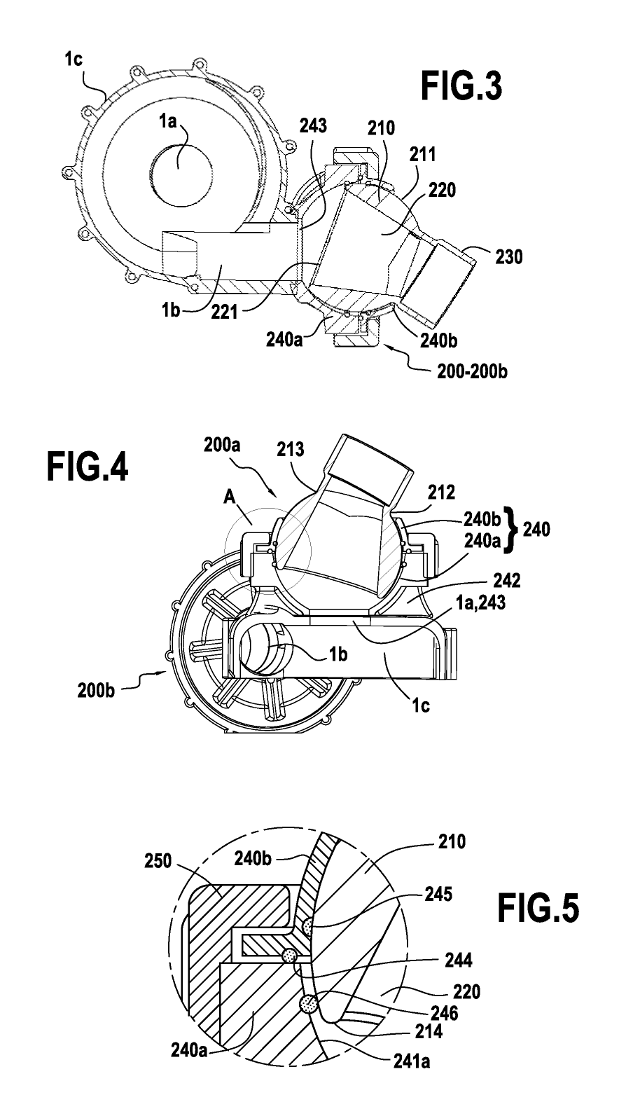

In FIG. 1A, the spherical balls 210 of the couplings 200a and 200b are pivoted into two opposite end positions, which positions are also shown in FIGS. 2A and 2B for the coupling 200b.

A pump equipped with spherical ball couplings of the invention makes it possible for at least one of the water flow pipes 10₁, 10₂ to be inclined at its end at which it is connected to the pump so that the axis of said pipe at its end 10₃ is inclined relative to the axis of the orifice to which it is connected via said coupling, and, when both the suction pipe and the delivery pipe are inclined relative to the axes of symmetry of the orifices of the pump with which they co-operate, the angle of inclination can be different for each of them.

A spherical ball coupling of the invention 200a, 200b, is made up of:

a—an internal spherical ball 210 having a convex outside surface 211 that has a spherical segment and that is surmounted by a hollow tubular end-piece 230 extending in alignment with a fluid-passing internal cavity defined by a surface of revolution of the frustoconical type 220, represented in this example by a straight generator line, said frustoconical cavity 220 presenting a first axis of revolution X₁X′₁. Said frustoconical cavity presents a small open base at a first section plane 221 and a large open circular base at a second section plane 222, the two section planes being perpendicular to the axis X₁X′₁. It can be understood that said two section planes 221 and 222 define the spherical segment of said spherical ball 210. At its end on the same side as said small open circular base at the first section plane 221, said spherical ball has a cylindrical tubular end-piece 230, whose second axis of revolution X₂X′₂ is inclined at an angle of a₂ relative to the first axis of revolution X₁X′₁ of said frustoconical internal cavity 220, the frustoconical internal cavity 220 being extended by the tubular internal cavity 231 of said cylindrical tubular end-piece. Due to the inclination a₂ between the two axes X₂X′₂ and X₁X′₁, the tubular internal cavity 231 presents a beveled end at the small open circular base of the frustoconical internal cavity at the first section plane 221, and a straight second end suitable for inter-fitting with the end of a water flow pipe 10₁, 10₂; and

b—a bearing part 240 in two pieces 240a and 240b. This bearing part has a concave inside surface of spherical segment against which the convex outside surface 211 of spherical segment of the spherical ball slides in rotation. The first bearing piece 240a has a first spherically concave inside surface 241a that is provided with a central perforation 243 in such a manner as to match a tubular end-piece on an orifice 1a, 1b of the pump or to match the pump orifice directly, said spherically concave bearing surface 241a-241b presenting the same axis of revolution XX′ as the pump orifice. Said first spherically concave surface 241a co-operates with the portion of the spherically convex surface 211 of the spherical ball 210 in the vicinity of its large base, at the second section plane 222. The remaining portion of the spherically convex surface 211 of the spherical ball 210 co-operates slidingly and bearingly with a second spherically concave inside surface 241b of a second piece 240b of bearing part that extends in continuity with the first spherically concave surface when the second piece 240b of bearing part is applied against the first piece 240a of bearing part. The second piece of bearing part is in the form of a rim-piece held in leaktight manner against said first piece 240a of the bearing part by a clamping collar 250 and by means of a first O-ring seal 244. The clamping collar 250 is provided with an internal thread suitable for co-operating with a complementary external thread on the cylindrical outside periphery of the upper portion of the first piece 240a of the bearing part.

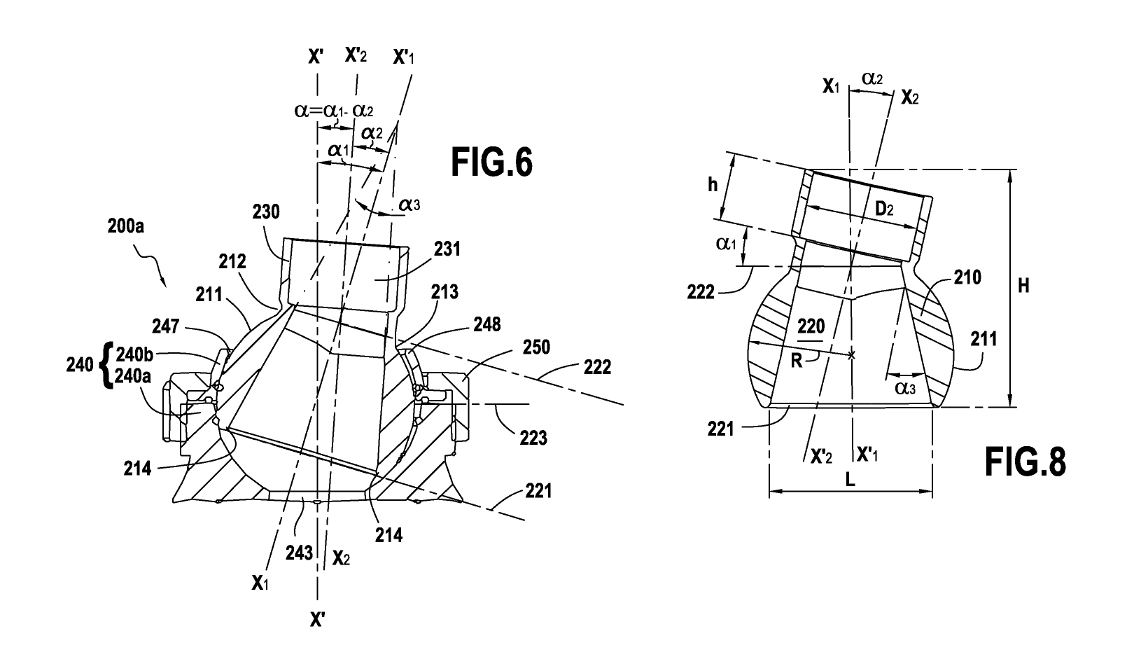

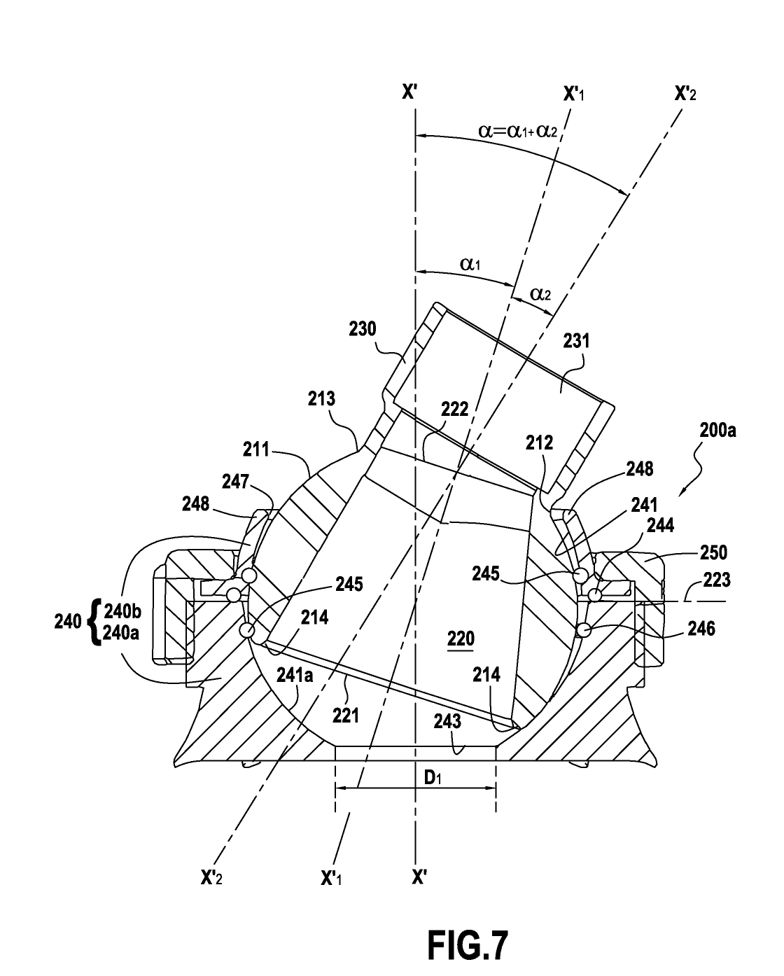

As shown in FIGS. 6 and 7, the sealing of the coupling 200a, 200b at the junction between said first piece 240a and said second piece 240b of the bearing part is supplemented by two other O-ring seals 245 and 246. The second O-ring seal 245 is interposed between the first spherically concave surface 241a and the spherically convex surface 211. The third O-ring seal 246 is interposed between the first spherically concave surface 241a of said first piece of bearing part and the spherically convex surface 211 of the spherical ball. Said second O-ring seal 245 and said third O-ring seal 246 are situated in the vicinities of respective ones of the ends of said second and first spherically concave surfaces 241b and 241a, on either side of and in the vicinity of said first O-ring seal 244. At the other end 248 of the second spherically concave surface 241b, a fourth O-ring seal 247 is placed that also provides sealing between the spherically convex surface 211 and the second spherically concave surface 241b.

The spherical ball coupling 200a that co-operates with the suction orifice 1a has a first piece 240a of bearing part that, on its underside, presents reinforcing ribs or ridges 242 that come to bear against the top surface of the cover 1c, around the suction orifice 1a, because the current of water tends to flatten the bearing part against said cover due to the direction of water flow from the outside towards the inside of the pump at said suction orifice.

The frustoconical surface of the frustoconical cavity 220 presents an inclination a₃ of about 25° relative to said first axis of revolution X₁X′₁ of said frustoconical cavity 220. When the spherical ball is such that its first axis of revolution X₁X′₁ is in alignment with the axis XX′ of the orifice of the pump and of the central orifice 243 in said first spherically concave surface 240a, the junction between said first and second spherically concave surfaces 240a and 240b and said first O-ring seal 244 corresponds substantially to the equator of the spherically concave surface 211.

The second axis of revolution X₂X′₂ of the cylindrical end-piece 230 is inclined at an angle a₂ of 13° relative to said first axis of revolution X₁X′₁ of the frustoconical internal cavity 220 of the ball 210. The ball 210 can pivot through an angle α₁ relative to the axis XX′ of said central orifice 243 or of the orifice 1a, 1b of the pump, which angle is less than or equal to a₁max of 17°.

FIGS. 6 and 7 show the two opposite maximum rotation positions of the spherical ball.

In FIG. 6, the spherical ball is in the minimum rotation position, its first axis of revolution X₁X′₁ being inclined at an angle −(a₁max−a₂) relative to the axis XX′ of the orifice 1a, 1b of the pump and of the central orifice 243 of said bearing part 240. In this position, the base 213 of the beveled end of the cylindrical end-piece 230, where its large side meets the spherically concave surface 211, comes into abutment against the end 248 of the second piece 240b of the bearing part, substantially at the fourth O-ring seal 247.

Similarly, in the other maximum inclination position shown in FIG. 7, in which said second axis of revolution X₂X′₂ of the cylindrical end-piece 230 is inclined at a maximum angle a₁max+a₂ relative to the axis XX′ of the central orifice 243 and of the orifice 1a, 1b of the pump, it is the base 212 of the small side of the beveled end of the cylindrical end-piece 230, where it meets the spherically convex surface 211, that comes into abutment against the end 248 of said second portion 240b of the bearing part.

In the two positions shown in FIGS. 6 and 7, it can be seen that the other end 214 of the spherically convex surface 211 that defines the large open circular base of the frustoconical cavity 220 at said first section plane 221, does not encroach on said central orifice 243, so as not to affect the fluid flow of the pump, and, at the diametrically opposite end, the end 214 of said convex surface 211 remains below said third O-ring seal 246 so as to preserve optimum leaktightness for said spherical ball coupling.

It can be understood that the spherically convex surface 211 defined between the two section planes 221 and 222 must be long enough in the direction of the axis X₁X′₁ for said spherically convex surface to remain always bearing against one of said first and second spherically concave bearing surfaces, but not too long so that the end 214 of said spherically convex surface 211 does not encroach on the central orifice 243, the choice of the values for the above-mentioned angles a₂ and a₁max making it possible to reconcile these two requirements.

In all of the rotation directions of a plane containing said second axis of revolution X₂X′₂ and said axis XX′ of the central orifice 243, in rotation through 360° relative to said axis XX′ of the orifice 243, said second axis X₂X′₂ can be inclined by a value from −amax to +amax, where amax=a₂+a₁max. But, in any given direction, in the absence of rotation relative to the axis XX′, i.e. in a given stationary plane containing said first and second axes X₁X′₂ and X₂X′₂ and the axis XX′ of the central orifice 243, the axis X₂X′₂ can be pivoted relative to an axis perpendicular to XX′ and can be inclined relative to the axis XX′ of the central orifice 243 by a value from −|a₁max−a₂| to (a₁max+a₂). Between these two extremes, the pivot axis of the cylindrical end-piece X₂X′₂ relative to the axis XX′ goes through a value of a=0, corresponding to a position in which said second axis of revolution X₂X′₂ of the cylindrical end-piece is parallel to the axis XX′ of the central orifice 243, insofar as the inclination of the cylindrical end-piece relative to the axis XX′ of the frustoconical cavity of the ball 210 causes the axis of the cylindrical end-piece X₂X′₂ to be offset laterally relative to the axis XX′ of the central orifice 243.

The diameter D2 of the tubular internal cavity 231 of the cylindrical end-piece 230 is slightly greater than the diameter D1 of the central orifice 243 because the ends of the pipes 10₁, 10₂, which ends are of the same diameter D1 as the central orifice 243 or as the orifice of the pump, come to fit into the cylindrical end-piece 230.

By way of illustration, the spherical ball 210 of a coupling 200a, 200b of the invention has the following dimensions:

radius of the spherically convex surface 211, R=57.50 millimeters (mm);

total height of the spherical ball 210, H=133 mm;

height of the top portion of the cylindrical end-piece 230, h=35 m;

inside diameter of the tubular cavity 231, D2=54.8 mm; and

diameter of the large open circular base of the spherical ball or distance between its two ends 214, L=96 mm.

Naturally, this counter-current swimming pump 1 is designed to be connected to water duct circuits feeding a swimming pool, at water delivery nozzles on a side wall of the swimming pool, so as to generate a stream, in particular for counter-current swimming.

However, it can be understood that an installation of the invention can include spherical ball couplings mounted on the delivery and suction orifices of a filtration pump that is also provided with a filtration enclosure interposed between the suction orifice of the pump and the cover of the pumping portion proper of the pump.

In the counter-current swimming pump 1 of FIGS. 1 and 1A, said cover comes to close the turbine casing body that encloses the turbine in the form of a blade or of a impeller, which turbine is mounted to rotate axially in turbine casing body 10b. The turbine casing body 10b is mounted on the electric motor 10a in such a manner as to be prevented from moving relative thereto.

However, as mentioned above, the couplings of the present invention can be applied to water pumps for swimming pools, and more particularly to a pump having a pumping portion proper body that is suitable for co-operating with a pump electric motor body, said pumping portion proper body including a pre-filter body provided with a suction orifice suitable for co-operating with a rigid water-inlet pipe for water coming from a swimming pool, said pre-filter body having or being suitable for co-operating with a turbine casing body provided with a delivery orifice and whose cover 1c is provided with a tangential delivery orifice suitable for delivering water into a pipe towards the swimming pool, preferably via a sand filter or via some other water treatment accessory, when said turbine is driven in rotation by an electric motor co-operating with said casing body. The pre-filter body is under relative suction pressure while the pump is operating, the water enters the pre-filter body via said suction orifice, it goes through a filtration system inside the pre-filter body, in particular of the basket type, and then enters the turbine casing body so as to be delivered via said delivery orifice towards the sand filter or other water treatment accessory. It is possible, in particular to implement ball couplings of the invention in a pump as described in French Patent Application 07 59635.

What is claimed is:

1. A swimming pool water pump having connection couplings for connection to fluid flow piping for the purpose of circulating a fluid, preferably for a swimming pool or for a swimming bath, at the fluid suction orifice of the pump and/or at the fluid delivery orifice of the pump, said pump having at least one said connection coupling integrated into the pump at said delivery orifice or at said suction orifice, said coupling having a spherical ball ending in a cylindrical tubular end-piece suitable for inter-fitting with the end of a said fluid flow pipe, wherein the axis of said cylindrical end-piece is inclined relative to the axis of said spherical ball, so that the axis of said cylindrical end-piece can pivot in all of the rotation directions relative to the axis of said delivery orifice or of said suction orifice of the pump, and presents an inclination relative to the axis of said orifice of the pump, by an angle α that, in absolute terms, is less than or equal to αmax, where αmax lies in the range 25° to 60°, and preferably in the range 30° to 45°.

2. A pump according to claim 1, wherein the axis of said cylindrical end-piece, which axis is referred to as the “second axis”, is inclined by a fixed angle α₂ having a value lying in the range 10° to 30°, and preferably lying in the range 10° to 20° relative to the axis of said spherical ball, which axis is referred to as the “first axis”, and said spherical ball can pivot through an angle α₁ from −α₁max to +α₁max between its said first axis and the axis of the orifice of the pump in any rotation direction relative to the axis of the orifice of the pump, where a₁max lies in the range 15° to 30°, and preferably 15° to 25°, so that the axis of said cylindrical end-piece can pivot relative to an axis perpendicular to the axis of said orifice of the pump by a value from 31 |a₁max−a₂| to (a₁max+a₂), in a given plane containing said first axis and said second axis, in a given rotation direction relative to the axis of said orifice of the pump.

3. A pump according to claim 2, wherein a₁max is substantially equal to the said angle α₂, of a value lying in the range 15° to 25°, and preferably of a value of 22.5°.

4. A pump according to claim 3, wherein:
said orifice of the pump is edged by a bearing part presenting a spherically concave bearing surface provided with a central orifice co-operating with the orifice of the pump and having the same axis of revolution as the axis of said orifice of the pump; and
said spherical ball has a spherically convex outside surface suitable for pivoting against said concave bearing surface, said spherically convex outside surface being defined by a sphere segment between two section planes that are perpendicular to an axis of revolution referred to as the “first axis” and that comprise a first section plane defining a small-diameter section and a second section plane defining a larger-diameter section, and said spherical ball also being provided with a fluid-passing internal cavity defined by a surface of revolution of the frustoconical type having a straight generator line or a curved generator line that is convex on the same side as the internal volume of the cavity about an axis of revolution corresponding to said first axis, so that said second axis that is the axis of said cylindrical end-piece can pivot to a value αmax=α₁max+α₂ in any rotation direction relative to the axis of said central orifice, said frustoconical cavity presenting a small open circular base at said first section plane and a large open circular base at said second section plane; and
a said cylindrical tubular end-piece extends from said first section plane, said second axis is inclined by an angle α₂ relative to said first axis of said frustoconical internal cavity, said frustoconical internal cavity being extended by the tubular internal cavity of said cylindrical tubular end-piece, which cavity presents a beveled end whose opening comes to be situated at said small open circular base of said frustoconical internal cavity at said first section plane, and a tubular second end suitable for inter-fitting with the end of a said water flow pipe.

5. A pump according to claim 4, wherein said spherical ball coupling has a said spherical concave surface separated into two pieces at a third section plane so that said bearing part has a lower first piece of bearing part that has a first spherically concave surface around said pump orifice, and above which an upper second piece of bearing part in the form of a rim-piece comes into abutment, the second spherically concave surface of which rim-piece extends in continuity with said first spherically concave surface, said upper second piece of bearing part in the form of a rim-piece being held in leaktight manner against said lower first piece of bearing part by a clamping collar and by means of an O-ring seal.

6. A pump according to claim 5, wherein said clamping collar is provided with a cylindrical thread suitable for co-operating in closure with a complementary thread on the cylindrical outside periphery of the upper portion of said lower first piece of the bearing part.

7. A pump according to claim 4, wherein said frustoconical internal cavity presents a straight generator line inclined at an angle lying in the range 20° to 30°, and preferably of about 25°, relative to said first axis of revolution.

8. A pump according to claim 1, having a said spherical coupling at each of its two orifices, namely its suction orifice and its delivery orifice, said axes of symmetry of which orifices are disposed perpendicularly.

9. A pump according to claim 8, wherein said axis of the suction orifice is substantially horizontal, and said axis of the delivery orifice is substantially perpendicular, and situated above the suction orifice.

10. A water flow installation for a swimming pool, said installation including a filtration pump or a counter-current swimming pump according to claim 1, which pump is connected to water flow pipes at least one said coupling at a said water suction orifice or a said water delivery orifice of said pump, in which coupling the end of said pipe inter-fitted with said cylindrical tubular end-piece of said coupling is inclined relative to the axis of symmetry of said orifice.

11. An installation according to claim 10, wherein the pump has two couplings having spherical balls, and the pipes at the two couplings are inclined by different angles of inclination relative to the axis of said orifice of the pump.
